(19) United States
(12) Patent Application Publication
(10) Pub. No.: US 2004/0194799 A1
(43) Pub. Date: Oct. 7, 2004

(54) Apparatus and method for surface cleaning using plasma

(76) Inventors: Jeong-Ho Kim, Kyunggi-do (KR); Gil-Gwang Lee, Kyunggi-do (KR)

Correspondence Address: Norman P. Soloway, Esq., HAYES SOLOWAY P.C., 130 W. Cushing Street, Tucson, AZ, 85701, US

(21) Appl. No.: 10/831,252

(22) Filed: Apr. 23, 2004

Related U.S. Application Data
(62) Division of application No. 10/038,553, filed on Jan. 4, 2002.

(30) Foreign Application Priority Data
Jan. 8, 2001 (KR) 2001-1018
Dec. 14, 2001 (KR) 2001-79425

(51) Int. Cl. B08B 7/00; B08B 7/04

(52) U.S. Cl. 134/1.3; 134/1.2; 134/4; 134/26; 134/31; 156/345.1; 156/345.5; 156/345.37; 156/345.33

(57) ABSTRACT

There is provided a surface cleaning apparatus and method using plasma to remove a native oxide layer, a chemical oxide layer, and a damaged portion from a silicon substrate surface, and contaminants from a metal surface. By absorbing potential in a grounded grid or baffle between a plasma generator and a substrate, only radicals are passed to the substrate, and HF gas is used as a second processing gas. Thus a native oxide layer, a chemical oxide layer, or a damaged portion formed on the silicon substrate during etching a contact hole is removed and the environment of a chamber is maintained constant by introducing a conditioning gas after each wafer process. Therefore, process uniformity is improved.

### PRIORITY

This application claims priority to an application entitled Method of Manufacturing Semiconductor Integrated Circuit and Apparatus Thereof filed in the Korean Industrial Property Office on Jan. 8, 2001 and assigned Serial No. 2001-1018, and to an application entitled Apparatus and Method for Dry Surface Cleaning Using Plasma filed in the Korean Industrial Property Office on Dec. 14, 2001 and assigned Serial No. 2001-79425, the contents of both of which are hereby incorporated by reference.

### BACKGROUND OF THE INVENTION

1. Field of the Invention

The present invention relates generally to a surface cleaning apparatus and method using plasma, and in particular, to a surface cleaning apparatus and method for, using plasma, removing a native oxide layer resulting from reaction between oxygen in the air and a silicon surface in fabrication of an integrated circuit such as a semiconductor device or TFT (Thin Film Transistor) LCD (Liquid Crystal Display), an oxide layer chemically formed on the silicon surface during processing, a damaged portion on the silicon surface, or contaminants on the silicon surface and the sidewalls of a contact hole.

2. Description of the Related Art

In general, metalization is needed to connect devices formed on an underlying silicon substrate by a metal layer in fabrication of an integrated circuit such as a semiconductor, TFT LCD, or FPD (Flat Panel Display). Formation of a contact hole is requisite for the metalization. The contact hole is formed usually by dry-etching an oxide layer using plasma. In the course of forming the contact hole, the underlying silicon surface is exposed. After the dry etch, a damaged portion is formed due to ion impact from the plasma, and contaminants including materials dissociated from etching gases and etched materials stick to a silicon surface and sidewalls. Because the damaged portion and contaminants may increase contact resistance or leakage current that is deadly adverse to device characteristics, they are removed by dry cleaning or wet cleaning during fabrication of an integrated circuit. Aside from the damaged portion and contaminants, a native oxide layer is formed due to reaction between oxygen in the air and the silicon surface. Therefore, the native oxide layer should also be removed by dry cleaning or wet cleaning before deposition of a conductive material after the contact hole is formed.

In addition, an oxide layer can be chemically formed by reaction between the silicon surface and a mixed solution of H2O2, H2SO4, and deionized water used for post-etch processing. The oxide layer influences subsequent steps and deteriorates electrical connection characteristics, thereby degrading the characteristics of a resulting semiconductor or TFT LCD circuit.

Along with the decrease of CD(Critical Dimension) in an integrated circuit, a self-aligned contact (SAC) has recently been used widely. During an SAC etch, an etch stopper layer formed of a silicon nitride layer is exposed. Thus, either sidewalls formed of a silicon oxide layer or the nitride layer should not be etched during surface cleaning in order to prevent short between an electrode surrounded by the nitride film and a conductive material filled in a contact hole, or leakage current.

Even if the silicon substrate surface underlying the contact hole is not exposed, a gate, a polysilicon electrode for a capacitor, or a connection line can be exposed. In this case, a damaged portion, an oxide layer, or contaminants should be removed as in the case where the silicon substrate surface is exposed.

A metal is used for a gate electrode or bit lines of a memory when necessary. The top portion of the metal is exposed during etching a contact hole. Similarly, contaminants on the metal and sidewalls must be removed and much attention should be paid to the removal because etched metal components are contained in the contaminants and are difficult to remove.

FIG. 1 is a schematic view of a conventional fluorine acid spray apparatus. Referring to FIG. 1, the conventional fluorine acid spray apparatus is comprised of a fluorine acid solution 10, a heating chamber 20, a substrate 30, a substrate mount 40, a fluorine solution tank 50 filled with a fluorine acid solution 60, and fluorine acid supply pipes 70 and 80. To prevent formation of a native oxide layer, oxygen is preliminarily removed by forming a fluorine layer on a silicon surface to react with the oxygen. Specifically, a fluorine acid layer is formed on a silicon surface by generating fluorine acid vapor using the fluorine acid spray apparatus and hardened by heat. Oxygen introduced into an etching device to etch the fluorine acid layer-having substrate or oxygen remaining in the etching device reacts chemically with the fluorine acid layer on the surface of the substrate and thus the oxygen is removed.

Despite the advantage of simplicity in device configuration and concept, however, the above conventional technology has a shortcoming in that it is difficult to effectively control fine process parameters.

UV (UltraViolet) light and ozone (O3) can be used for surface cleaning. That is, a silicon surface is oxidized by reaction between silicon and O3 dissociated by UV light and the oxide layer is removed by wet etch. However, oxidation takes a long time, leading to slow processing.

FIG. 2 is a schematic view of a conventional plasma etching apparatus plasma is generated in a plasma generator 100 by introducing H2 and N2 through a first processing gas inlet 90 and then NF3 is introduced through a second processing gas inlet 110, thereby etching a silicon substrate 120 in a chamber 140 with gases exhausted through an outlet 130.

The NF3 gas as a main processing gas accelerates plasma dissociation and activation, so that excess fluorine atoms and ions involved in the etching are generated. As a result, the silicon surface is over-etched deeper than a damaged portion, or a BPSG (Borophosphosilicate glass) oxide layer or a nitride layer that must avoid etching may also be etched.

### SUMMARY OF THE INVENTION

It is, therefore, an object of the present invention to provide a surface cleaning apparatus and method using plasma, for removing a native oxide layer or a chemical oxide layer formed on a silicon surface before growth of a gate oxide layer in order to prevent deterioration in the characteristics of the gate oxide layer.

It is another object of the present invention to provide a surface cleaning apparatus and method using plasma, for removing a native oxide layer/a chemical oxide layer, a damaged portion, and contaminants from a silicon surface exposed during etching a oxide layer for formation of a contact hole in order to prevent the increase of contact resistance and leakage current.

It is also another object of the present invention to provide a surface cleaning apparatus and method using plasma, for removing contaminants such as polymers on the sidewalls of a contact hole and the upper surface of an underlying metal layer when the contact hole is etched for connection to the metal layer.

It is a further object of the present invention to provide a surface cleaning apparatus and method using plasma, for growing good quality epitaxial silicon by removing a native oxide layer or a chemical oxide layer from a silicon surface during an epitaxial silicon growing process in fabrication of an integrated circuit.

It is still another object of the present invention to provide a surface cleaning apparatus and method using plasma, for growing good quality hemispherical grains (HSGs) by removing a native oxide layer or a chemical oxide layer from an underlying silicon surface in an HSG silicon formation process.

It is yet another object of the present invention to provide a surface cleaning apparatus and method using plasma, for improving process uniformity.

The foregoing and other objects of the present invention can be achieved by providing a surface cleaning apparatus and method using plasma. According to one aspect of the present invention, the surface cleaning apparatus using plasma has a chamber that can be maintained in a vacuum state, a substrate mount in the chamber, for mounting a silicon substrate, a first processing gas inlet for introducing a carrier gas into the chamber to generate and maintain plasma, a plasma generator for forming plasma out of the first processing gas, a filter between the plasma generator and the substrate mount, for passing only radicals to the substrate, and a second processing gas inlet between the plasma generator and the filter, for introducing a second processing gas into the chamber.

Preferably, the plasma generator uses a microwave generator as an energy source for plasma generation.

Preferably, a wall heat jacket is further provided for maintaining the walls of the chamber at a predetermined temperature to concentrate the radicals on the surface of the substrate by preventing deposition of the radicals and formation of a byproduct layer with the radicals.

Preferably, the filter is grounded, or a grid or baffle with a square-wave or sine-wave AC (alternating current) voltage applied is used as the filter.

More preferably, a third processing gas inlet is further provided for introducing a conditioning gas into the chamber to maintain the environment of the chamber constant after processing each wafer.

According to another aspect of the present invention, in the surface cleaning method using plasma, for removing a damaged portion and an unwanted oxide layer formed during etching for a contact hole on a silicon substrate having at least one layer including an insulation layer, a polymer layer is first formed on the oxide layer. The polymer layer and the oxide layer are removed by annealing, and the damaged portion of the surface of the silicon substrate is removed.

Preferably, in the polymer layer formation step, plasma is formed by introducing a first processing gas containing H2 or N2, only radicals are passed to the silicon substrate by filtering the plasma, and a second processing gas containing a halogen element is introduced.

Preferably, the second processing gas is at least one of HF, HCl, BCl3, HBr, and ClF3.

Preferably, the polymer layer and the oxide layer are removed by annealing using a UV lamp or IR lamp, or by annealing in a heat chamber.

Preferably, the damaged portion of the silicon substrate surface is removed by annealing in a heat chamber.

More preferably, the damaged portion removal step is performed in-situ in the same chamber as the polymer layer and the oxide layer are removed.

According to a further aspect of the present invention, in the surface cleaning method using plasma for fabrication of an integrated circuit in a surface cleaning apparatus having a chamber that can be maintained in a vacuum state, a substrate mount for mounting a silicon substrate, a first processing gas inlet for introducing a carrier gas for generation and maintenance of plasma, a plasma generator, a filter for passing only radicals to the substrate, and a second processing gas inlet, the first processing gas is introduced into the chamber, plasma is formed out of the first processing gas in the plasma generator, a second processing gas is introduced into the chamber, and then a third processing gas is introduced into the chamber to maintain the environment of the chamber constant after processing each wafer.

Preferably, the first processing gas contains one of H2 and N2.

Preferably, the filter is grounded or receives an AC voltage.

Preferably, the second processing gas contains a halogen element.

More preferably, the second processing gas is at least one of HF, HCl, BCl3, HBr, and ClF3.

Preferably, the third processing gas contains at least of H, F, O and N.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic view of a conventional fluorine acid spray device;

FIG. 2 is a schematic view of a conventional plasma etching apparatus;

FIG. 3 is a schematic view of an embodiment of plasma etching apparatus according to the present invention;

FIG. 4 is a schematic view of another embodiment of the plasma etching apparatus according to the present invention;

FIGS. 5A to 5E are sectional views sequentially illustrating an embodiment of a process of removing a native oxide layer and a damaged portion of a silicon substrate surface; and

FIGS. 6A and 6B are SEM (Scanning Electro Microscope) images illustrating contact profiles.

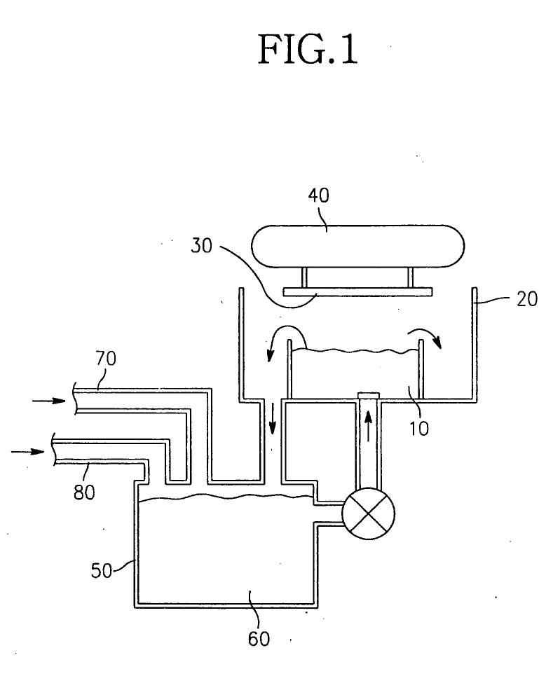

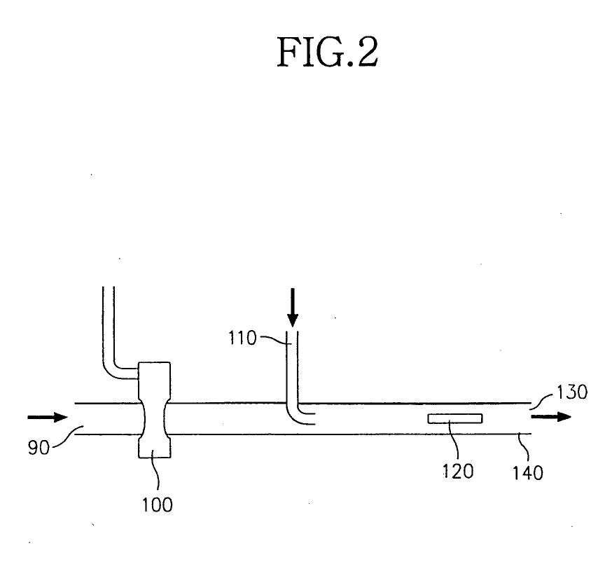

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail since they would obscure the invention in unnecessary detail.

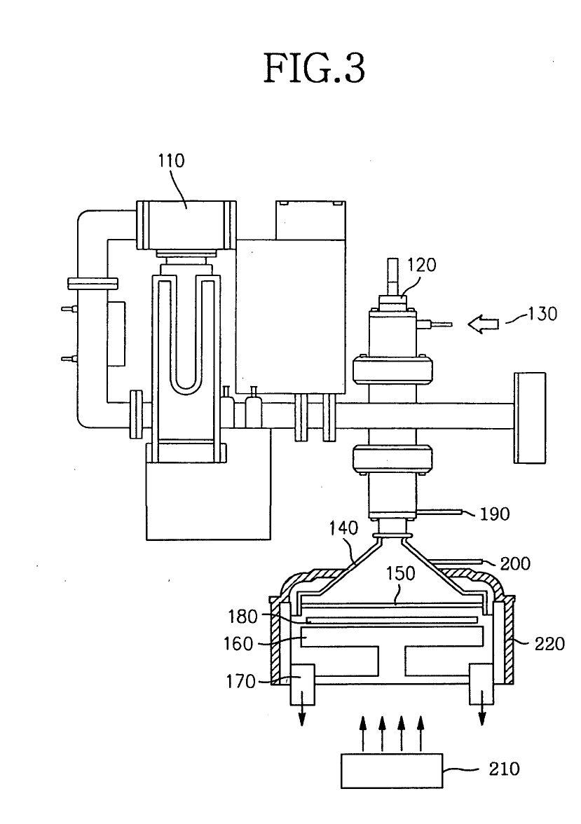

FIG. 3 illustrates the structure of an embodiment of plasma etching apparatus according to the present invention. The plasma etching apparatus performs dry cleaning using a microwave plasma. Referring to FIG. 3, after a silicon substrate 180 is mounted on a substrate mount 160 under a chamber 140 that can be maintained in a vacuum state, N2, H2, or a mixture of the gases is introduced through a first processing gas inlet 130. The N2, H2, or mixture gas serves as a carrier gas for generating and maintaining plasma. Subsequently, plasma is generated by operating a microwave source module 110 and a plasma applicator 120 and HF gas is introduced through a second processing gas inlet 190. A fluorine-containing halogen element, or a halogen element such as HCl, BCl3, HBr, or ClF3 can be a substitute for HF. The plasma passes through a filter 150, while moving down toward the substrate 180. The filter 150, being a grounded baffle or grid, absorbs potential so that only radicals reach the silicon substrate 180. A heater 210 for annealing, where in the damaged portion of the silicon substrate surface is removed by annealing in a heat chamber. A wall heat jacket 220 maintains the walls of the chamber 140 at an appropriate temperature to prevent the radicals from sticking to the walls of the chamber 140 and forming a byproduct layer and to concentrate the radicals on the surface of the silicon substrate 180. H or F gas as a conditioning gas is introduced through a third processing gas inlet 200 to maintain the environment inside the chamber 140 constant and thus increase etch reproducibility after etching. The conditioning gas is H, F, O or N, or a mixture of the gases.

The used processing gases are exhausted through an outlet 170.

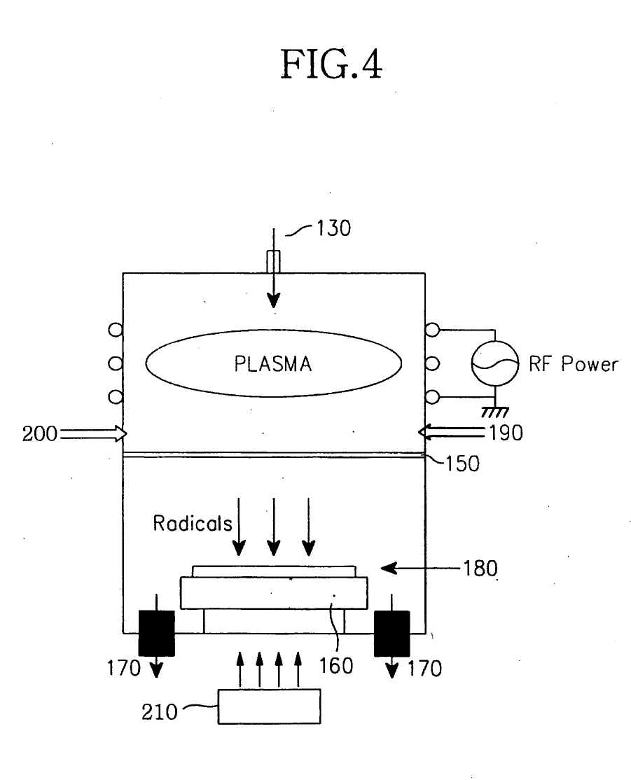

FIG. 4 illustrates the structure of another embodiment of the plasma etching apparatus according to the present invention. The plasma etching apparatus performs dry cleaning using a remote plasma. Referring to FIG. 4, this plasma etching apparatus is similar to the plasma etching apparatus using a microwave plasma except that RF power is supplied to generate plasma. The plasma etching apparatus is well known to those skilled in the field and thus its description is avoided here.

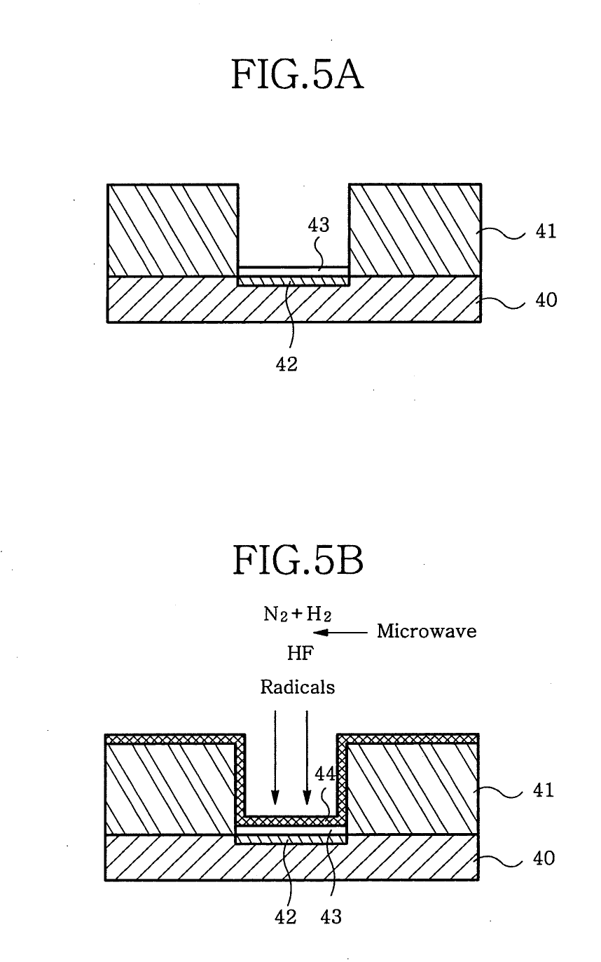

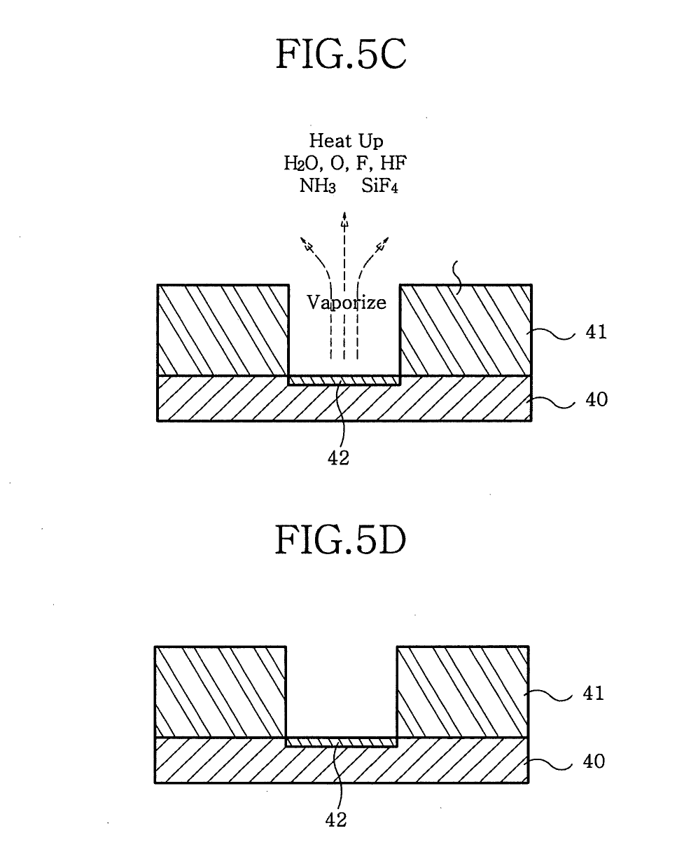

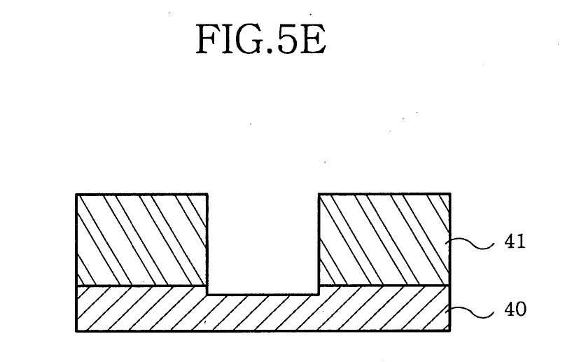

FIGS. 5A to 5E are sectional views sequentially illustrating a process of removing a native oxide layer and a damaged portion of a silicon substrate surface according to an embodiment of the present invention.

FIG. 5A illustrates the step of forming an interlayer insulation layer 41 on a silicon substrate 40 and then forming a contact hole by etching the interlayer insulation layer 41 in a contact area. The surface of the silicon substrate 40 exposed in the contact area is damaged during the etching. As a result, a damaged portion 42 and a native oxide layer 43 are sequentially formed on the silicon substrate 40. Since the native oxide layer 43 and the damaged portion 42 increase contact resistance or leakage current and as a result, deteriorates device characteristics, they must be removed.

FIG. 5B illustrates the step of forming an NxHyFz polymer layer 44 or a byproduct on the native oxide layer 43, the interlayer insulation layer 41 and the sidewalls of a contact hole using plasma generated out of H2 or N2 gas, and HF gas as a second processing gas. By grounding a grid or baffle for filtering the plasma, or applying AC voltage, only radicals in the plasma reach the substrate surface.

FIG. 5C illustrates the step of removing the polymer layer 44 by annealing. As the components of the polymer layer 44 are decomposed by annealing, the decomposed component are combined with the components of the underlying native oxide layer 43 and excited to N2O, O, F, HT, NH3, SiF4, etc and then removed. Instead of annealing, the polymer layer or byproduct can be removed using a UV lamp or IR (InfraRed) lamp.

FIG. 5D illustrates the step of performing hydrophobic cleaning on the silicon substrate surface after the native oxide layer 43 is removed by annealing.

FIG. 5E illustrates the step of removing the silicon damaged portion 42 in-situ in the same chamber. The silicon damaged portion 42 can be removed using a remote plasma of at least one of HF/H2, HF/O2, NF3/O2, SF6/O2, and CF4/O2 or appropriately combining a gas such as NF3, CF4, and C2F2, a gas such as O2, CO2, NO2, and N2, and an inert gas such as He, Ne, Xe, and Ar. When removing the silicon damaged portion of a silicon substrate caused during processing including metal etching such as etching for formation of a metal contact window, it is more effective to use a remote plasma including Cl, like HCL, ClF3 and so on.

A table shown below is a comparison between the present invention using HF as a second processing gas and the conventional technology using NF3 as a second processing gas. As seen from the table, the present invention is much improved in etch rate, silicon substrate roughness, and metal contamination.

| Items | | HF | NF3 | Reference |
|---|---|---|---|---|
| Etch Rate (/min) | | 42 | 30 | — |
| Selectivity of Oxide to | | >8 | >6 | — |
| Nitride (or Si-sub) | | | | |
| SI Surface Roughness | | 0.2803 | 0.3623 | 0.1043 |
| (RMS: nm) | | | | |
| Metal | Al | 7.91E+10 | 4.38E+12 | 3.44E+09 |
| Contamination | Cr | 1.79E+09 | 5.36E+09 | 1.79E+09 |
| (/cm3) | Fe | 3.98E+10 | 1.43E+11 | 1.66E+09 |
| | Ni | 1.60E+09 | 9.61E+09 | 1.60E+09 |

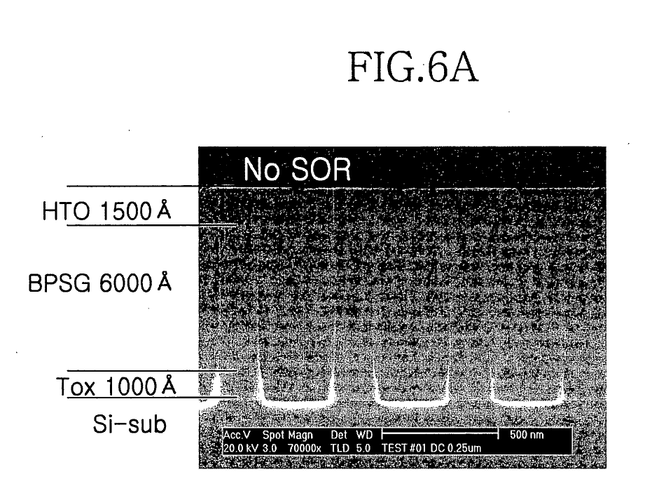

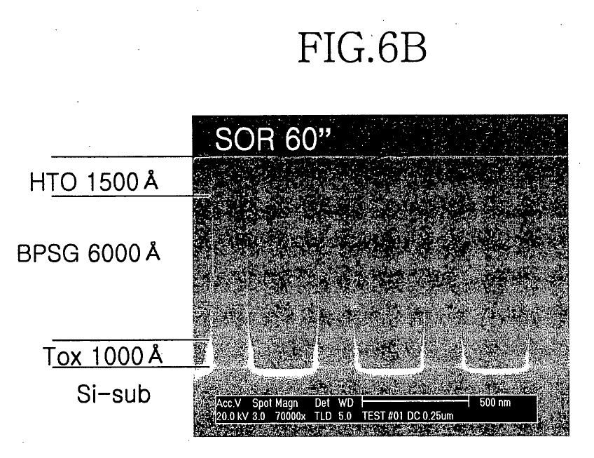

FIG. 6A illustrates a contact profile before removing a native oxide layer and FIG. 6B illustrates a contact profile during processing the native oxide layer for 60 seconds. There are little changes in the contact profiles in terms of CD and substrate damage.

In accordance with the present invention as described above, (1) deterioration of the characteristics of a gate oxide layer is prevented by removing a native oxide layer or a chemical oxide layer formed on a silicon surface before growth of the gate oxide layer; (2) the increase of contact resistance and leakage at a contact are prevented by removing a native oxide layer or a chemical oxide layer formed on a silicon surface exposed after etching for a contact hole and a portion of the silicon surface damaged during etching; (3) metal contact resistance is reduced by removing organic contaminants such as polymers existing at the boundary between the sidewalls of a contact and an underlying metal during etching the metal contact hole; (4) good quality epitaxial silicon is grown by removing a native oxide layer or a chemical oxide layer from a silicon surface in an epitaxial silicon growing process; (5) good quality HSGs are grown by removing a native oxide layer or a chemical oxide layer from a silicon surface in an HSG silicon forming process; and (6) process uniformity is improved by introducing a conditioning gas after processing each wafer and thus maintaining the environment of a chamber constant.

While the invention has been shown and described with reference to certain preferred embodiments thereof, it will be understood by those skilled in the art that various changes in form and details may be made therein without departing from the spirit and scope of the invention as defined by the appended claims.

1. A surface cleaning method using plasma, for removing a damaged portion and an unwanted oxide layer formed during etching for a contact hole on a silicon substrate having at least one layer including an insulation layer, the method comprising the steps of:
forming a polymer layer on the oxide layer;
removing the polymer layer and the oxide layer by annealing; and
removing the damaged portion of the surface of the silicon substrate.

2. The method of claim 1, the polymer layer formation step comprises the steps of:
forming plasma by introducing a first processing gas containing H2 or N2;
passing only radicals to the silicon substrate by filtering the plasma; and
introducing a second processing gas containing a halogen element.

3. The method of claim 2, wherein the second processing gas is at least one of HF, HCl, BCl3, HBr, and ClF3.

4. The method of claim 1, wherein the polymer layer and the oxide layer are removed by annealing using a UV lamp or IR lamp.

5. The method of claim 2, wherein the polymer layer and the oxide layer are removed by annealing using a UV lamp or IR lamp.

6. The method of claim 1, wherein the polymer layer and the oxide layer are removed by annealing in a heat chamber.

7. The method of claim 2, wherein the polymer layer and the oxide layer are removed by annealing in a heat chamber.

8. The method of claim 1, wherein the damaged portion of the silicon substrate surface is removed using remote plasma formed out of a fluorine (F)-containing gas.

9. The method of claim 8, wherein the fluorine-containing gas is at least one of HF/H2, HF/O2, NF3/O2, SF6/O2, and CF4/O2.

10. The method of claim 1, wherein the damaged portion of the silicon substrate surface is removed using remote plasma formed out of a Cl-containing gas.

11. The method of claim 1, wherein the damaged portion of the silicon substrate surface is removed by annealing in a heat chamber.

12. The method of claim 6, wherein the damaged portion removal step is performed in-situ in the same chamber after removing the polymer layer and the oxide layer.

13. The method of claim 7, wherein the damaged portion removal step is performed in-situ in the same chamber after removing the polymer layer and the oxide layer.

14. A surface cleaning method using plasma for fabrication of an integrated circuit in a surface cleaning apparatus having a chamber that can be maintained in a vacuum state, a substrate mount for mounting a silicon substrate, a first processing gas inlet for introducing a carrier gas for generation and maintenance of plasma, a plasma generator, a filter for passing only radicals to the substrate, and a second processing gas inlet, the method comprising the steps of:
introducing the first processing gas into the chamber;
forming plasma out of the first processing gas in the plasma generator; and
introducing a second processing gas into the chamber.

15. The method of claim 14, wherein the first processing gas contains one of H2 and N2.

16. The method of claim 14, wherein the second processing gas contains a halogen element.

17. The method of claim 14, wherein the second processing gas is at least one of HF, HCl, BCl3, HBr, and ClF3.

18. A surface cleaning method using plasma for fabrication of an integrated circuit in a surface cleaning apparatus having a chamber that can be maintained in a vacuum state, a substrate mount for mounting a silicon substrate, a first processing gas inlet for introducing a carrier gas for generation and maintenance of plasma, a plasma generator, a filter for passing only radicals to the substrate, a second processing gas inlet, and a third processing gas inlet for introducing a third processing gas to maintain the environment of the chamber constant after processing each wafer, the method comprising the steps of:
introducing the first processing gas into the chamber;
forming plasma out of the first processing gas in the plasma generator;
introducing a second processing gas into the chamber; and
introducing the third processing gas into the chamber to maintain the environment of the chamber constant after processing each wafer

19. The method of claim 18, wherein the first processing gas contains one of H2 and N2.

20. The method of claim 18, wherein the second processing gas contains a halogen element.

21. The method of claim 18, wherein the second processing gas is at least one of HF, HCl, BCl3, HBr, and ClF3.

22. The method of claim 18, wherein the third processing gas contains at least of H, F, O and N.

23-31 (cancelled)

32. The method of claim 19, wherein the third processing gas contains at least one of H, F, O and N.

33. The method of claim 20, wherein the third processing gas contains at least one of H, F, O and N.

34. The method of claim 21, wherein the third processing gas contains at least one of H, F, O and N.
